(19) United States
(12) Patent Application Publication
(10) Pub. No.: US 2003/0172010 A1
(43) Pub. Date: Sep. 11, 2003

(54) System and method for analyzing data

(75) Inventors: Harish Butani, Fremont, CA (US); Mark Cummings, San Jose, CA (US)

Correspondence Address: David R. Stevens, Stevens & Sponseller LLP, Suite 201, 99 North First Street, San Jose, CA, 95113, US

(73) Assignee: Agile Software Corporation, San Jose, CA

(21) Appl. No.: 10/323,564

(22) Filed: Dec. 17, 2002

Related U.S. Application Data
(60) Provisional application No. 60/363,400, filed on Mar. 8, 2002.

(51) Int. Cl. G06F 17/60

(52) U.S. Cl. 705/29

(57) ABSTRACT

A system and method for analyzing data identifies a first set of analysis results based on a first set of data and an analysis strategy. A second set of data, which is a modification of the first set of data, is analyzed using the analysis strategy to generate a second set of analysis results. The second set of analysis results are arranged in a hierarchical format. The first set of analysis results are compared with the second set of analysis results to identify differences in the two analysis results.

### RELATED APPLICATIONS

The present application is related to U.S. patent application Ser. No. ______, filed on the same day as this application, and entitled, “SYSTEM AND METHOD FOR MANAGING AND MONITORING SUPPLY COSTS”, the contents of which are hereby incorporated by reference.

### TECHNICAL FIELD

The systems and methods described herein analyze and compare data, such as data contained in a bill of materials.

### BACKGROUND

A bill of materials is commonly used in the product sourcing and product manufacturing processes. A bill of materials typically contains data regarding various components, elements, services, processes, etc. that make up a product, a service, a process, a project, or the like. Common procedures collect all data related to a particular bill of materials prior to analyzing that bill of materials data. These common procedures do not support the analysis of bill of material data when only a portion of the bill of material data has been collected. This limitation may impede the development of an acceptable bill of materials.

Additionally, existing procedures that handle bill of materials data do not support analyzing the impact of various changes on a bill of materials. For example, if the data in the bill of materials changes, existing procedures cannot easily analyze the impact of this data change on the overall bill of materials. Similarly, if the analysis strategy or price selection strategy related to the bill of materials changes, these existing procedures do not support an overall analysis of these changes on a bill of materials and/or the manufacturing process.

Accordingly, there is a need for systems and methods that support flexible data analysis, including analysis of the impact of various changes on a set of data.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 illustrates an exemplary environment capable of analyzing and comparing data.

FIG. 2 is a block diagram illustrating a data collection module coupled to multiple data sources.

FIG. 3 is a flow diagram illustrating a procedure for analyzing a set of data.

FIG. 4 is a block diagram illustrating an example traversal tree having multiple nodes.

FIG. 5 is a flow diagram illustrating a procedure for identify the impact of a change on a set of data.

FIG. 6 illustrates an embodiment of a multi-scenario analysis tree.

FIG. 7 illustrates various components of an exemplary computing device.

### DETAILED DESCRIPTION

The systems and methods described herein analyze one or more sets of data, such as bill of materials data. The data analysis includes determining the impact of one or more changes on a set of data. The results of the analysis are displayed in a manner that allows a user to compare the results of different analysis procedures and identify differences in those results. Various types of changes can be analyzed, such as changes to the analysis strategy or changes to data elements in the set of data.

The systems and methods described herein permits a user or system to perform a variety of analysis functions related to a set of data. For example, the user can identify the most expensive components, what percentage of data is associated with a particular supplier or manufacturer, or the cost impact of changing one or more suppliers. The analysis process is flexible and allows the user to change analysis strategies, data elements and other parameters.

As used herein, a “bill of materials” is any collection of data that identifies various components, elements, services, or processes that make up a product, a service, a process, or a project. For example, a bill of materials may identify multiple components that are used to assemble a finished product. In this example, the bill of materials my specify various information regarding each component, such as part numbers, quantities and the manner in which the multiple components are assembled with one another. In another example, a bill of materials identifies multiple services that are performed to complete a particular project. In this example, the bill of materials specifies how the multiple services are to be performed and how the results of the multiple services are used to complete the particular project. A particular bill of materials may contain any number of entries related to any number of products, services, processes or projects.

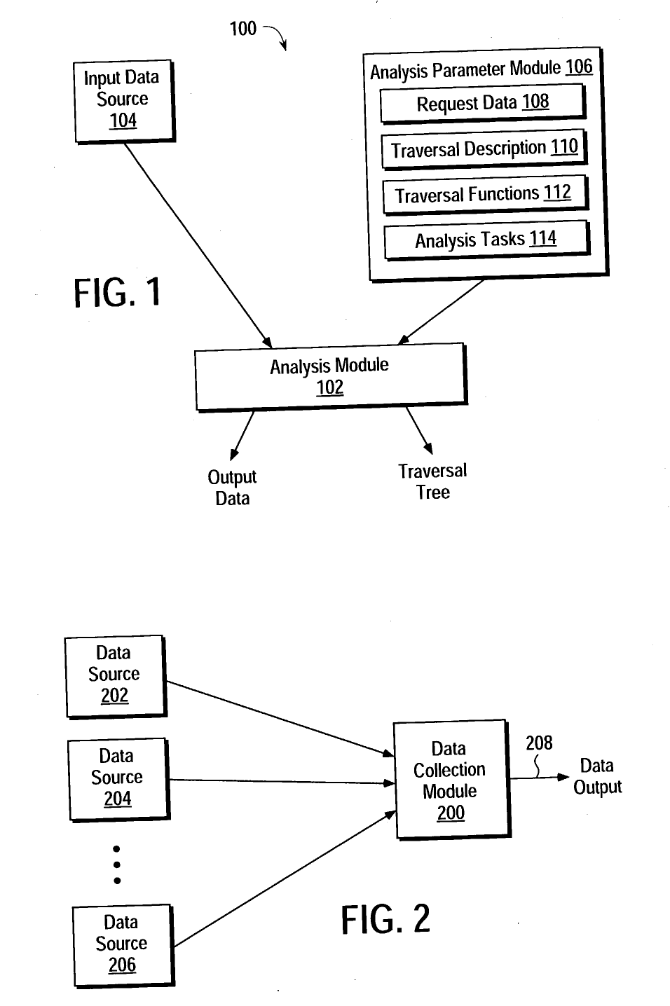

FIG. 1 illustrates an exemplary environment 100 capable of analyzing and comparing data. The components of environment 100 are capable of analyzing and comparing multiple sets of data and comparing the results of multiple executions of an analysis process. An analysis module 102 performs various analysis procedures discussed herein. For example, analysis module 102 can analyze a set of data, analyze the impact of changes to a set of data and compare two different sets of data to identify differences in the data. In a particular embodiment, analysis module 102 processes data representing a bill of materials. In alternate embodiments, analysis module 102 processes multiple types of data, including data representing a bill of materials.

Analysis module 102 is coupled to one or more input data sources 104, which provide data to analysis module 102. Input data source 104 may be a storage device, a computing device, a data consolidation device, or any other system or component capable of providing data to analysis module 102. An analysis parameter module 106 is also coupled to analysis module 102. Analysis parameter module 106 contains information regarding the analysis that is to be performed by analysis module 102. For example, a request data parameter 108 identifies the data to be analyzed by analysis module 102. The request data parameter 108 may include the identity of one or more data sources from which the data can be retrieved.

Analysis parameter module 106 also includes a traversal description 110, which describes how to build a “traversal tree” and what actions to perform while building the traversal tree. As discussed in greater detail below, a traversal tree is generated by analysis module 102 as a result of analyzing one or more sets of data. The traversal tree generated by the analysis module 102 may also be referred to as a “tree” or a “data hierarchy”.

One or more traversal functions 112 are included in analysis parameter module 106. Traversal functions 112 are provided with the current state of the analysis (or state of the traversal tree) and, in response, identify the next set of objects to visit (or analyze). Analysis parameter module 106 also includes one or more analysis tasks 114, which perform a particular analysis on one or more data elements in a set of data. A particular analysis task 114 is provided with the current state of the analysis (or state of the traversal tree) and, in response, performs its associated analysis and provides the results of the analysis as part of an output data stream. Additional details regarding traversal functions 112 and analysis tasks 114 are provided below.

Analysis module 102 performs a particular analysis process by analyzing input data from the input data source 104 according to the information contained in the analysis parameter module 106. During the analysis process, analysis module 102 generates various output data, such as the results of specific analysis tasks and data representing the traversal tree that is generated as the analysis process executes. The traversal tree provides information regarding the operations performed during the analysis process. The output data may be communicated to another system or device (such as a storage device), or may be displayed, printed, or otherwise presented to a system or user for review. Other systems or devices (not shown) may perform further analysis on the output data.

FIG. 2 is a block diagram illustrating a data collection module 200 coupled to multiple data sources 202, 204 and 206. Data collection module 200 may store data received from data sources 202-206 or may simply receive data from the data sources and transmit the data to another system or device on a data output port 208. Data sources 202-206 may be any type of data source communicating with data collection module 200 using any type of data communication protocol and any type of data transmission format. In a particular implementation, data collection module 200 may collect data from less than all of the data sources 202-206 at a particular moment. In a particular embodiment, the data output 208 from data collection module 200 is provided to analysis module 102 (FIG. 1) as input data. Although three data sources 202-206 are shown in FIG. 2, a particular embodiment may include any number of data sources coupled to data collection module 200.

In a particular embodiment, data collection module 200 of FIG. 2 creates the appearance of a uniform data source by transforming the data received from the multiple data sources 202-206 into a common format. Thus, the device or system receiving the data output from the data collection module sees a single, uniform data source rather than multiple separate data sources.

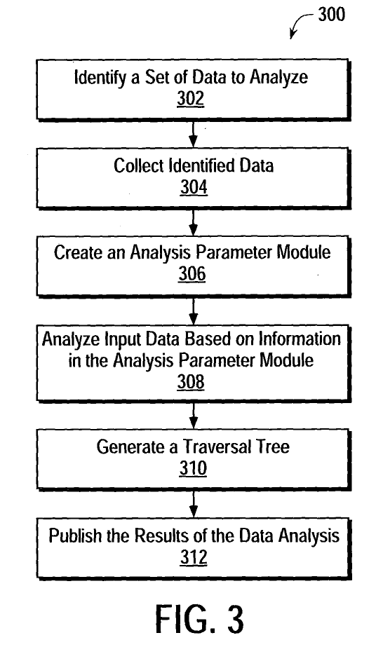

FIG. 3 is a flow diagram illustrating a procedure 300 for analyzing a set of data. Although FIG. 3 illustrates the analysis of a single set of data, other figures described below illustrate procedures for comparing and analyzing multiple sets of data. Procedure 300 begins by identifying a set of data to analyze (block 302) and collecting the identified data (block 304). The procedure then creates an analysis parameter module (block 306). As discussed above, an analysis parameter module contains information regarding the analysis that is to be performed on the set of data. In a particular embodiment, procedure 300 retrieves data from a previously created analysis parameter module rather than creating an analysis parameter module.

Procedure 300 continues by analyzing input data (i.e., the data collected in block 304) based on information contained in the analysis parameter module (block 308). As part of the data analysis process, procedure 300 generates a traversal tree (block 310). Additional details regarding traversal trees are provided below. Finally, procedure 300 publishes the results of the data analysis (block 312).

In a particular embodiment, the analysis of the input data mentioned above with respect to block 308 results in the building of a “traversal tree”. A traversal tree is described as a set of rules. A particular rule is associated with an object type. Each rule defines one or more tasks that are executed when the object associated with the rule is reached. The rule also defines how to continue traversing the set of data (e.g., identifying the next step or function to perform). Each task contained in a rule may be an analysis task or a traversal task. Analysis tasks analyze data or other information associated with one or more nodes of the traversal tree. A traversal task moves a pointer (or other position indicator) to another object in the traversal tree after the analysis tasks have completed their associated tasks. A traversal task is also referred to as a traversal function and an analysis task is also referred to as an analysis function.

As discussed above, analysis parameter module 106 (FIG. 1) includes a traversal description 110 and traversal functions 112. The traversal description and the traversal functions are used by the analysis module 102 to generate a traversal tree based on the input data. The traversal tree includes information regarding the objects in the received data (e.g., the bill of materials) that were considered for analysis. The traversal tree also indicates the order in which the data was processed and what object relationships were considered. Additionally, the traversal tree may identify one or more analysis tasks performed on the received data.

The traversal description provides instructions regarding how to build a traversal tree and what actions to perform while building the traversal tree. An example traversal description is provided below.

| | |
|---|---|
| Root | Traverse eval (froots, “) |
| Item | Do Task rollDemand, |
| | Traverse flatten (eval ([this], ‘born’) |
| | Traverse flatten (eval ([this], ‘ami’) |
| | Traverse responseDiscovery, |
| | Traverse priceDiscovery, |
| | Do Task priceSelection, |
| | Do Task costRollup |
| MPN | Do Task rollDemand, |
| | Do Task responseDiscovery, |
| | Do Task priceDiscovery, |
| | parent._aly_class != “c.amlentry’: Do Task priceSelection |
| Price | Pass |
| Response | Pass |
| BomEntry | Do Task addToOutput, |
| | Traverse eval ([this], ‘childRef’) |

As used herein, a traversal definition includes a set of rules and a traversal order, such as depth-first or breadth-first. A traversal definition may also be referred to as a traversal description. A rule is associated with a particular type of object, such as an item, a manufacturer part, or a price. A rule may have an associated filter, which implies that the rule is applied to an object if the object satisfies the filter criteria. A rule is comprised of a set of tasks. A task represents a unit of work and is described by a function definition (e.g., a function name and one or more input parameters). A particular task can be a traversal task or an analysis task. A task may have an associated filter—the task is executed for an object if the object satisfies the filter criteria. A traversal function includes an associated set of objects to visit.

When analyzing input data, various traversal functions are executed. The format of a traversal function is:

Traversal Fn(node, traversalTree, input, output, request)→Objects

A traversal function is provided with the current state of the traversal process and is asked for the next object or set of objects to “visit” in the traversal tree. A particular traversal function is an expression evaluation task. For example, when analyzing a particular item (or node) in the traversal tree, the bill of materials for that particular item can be viewed by executing “flatten (eval([this], ‘bom’))”. Since the bill of materials (abbreviated “bom” or “BOM”) is a collection of data, the “flatten” operation is used to flatten out the bill of materials data and return individual data entries rather than a collection of data entries.

The analysis process receives the output of each traversal function (i.e., one or more objects) and create nodes for the objects and evaluates the rules for those objects. An analysis function performs a particular analysis on the input data. The format of an analysis function is:

Analysis Fn(node, traversalTree, input, output, request)

The analysis function is provided with the current state of the traversal tree. An analysis function does not typically alter the traversal tree. Instead, the analysis function generates data, based on its analysis, that is transmitted from the analysis module (e.g., module 102 in FIG. 1) as output data. In a particular embodiment, the output data from the analysis module is collected by an output data source. This output data source may then be accessed by other devices or systems to retrieve data stored therein.

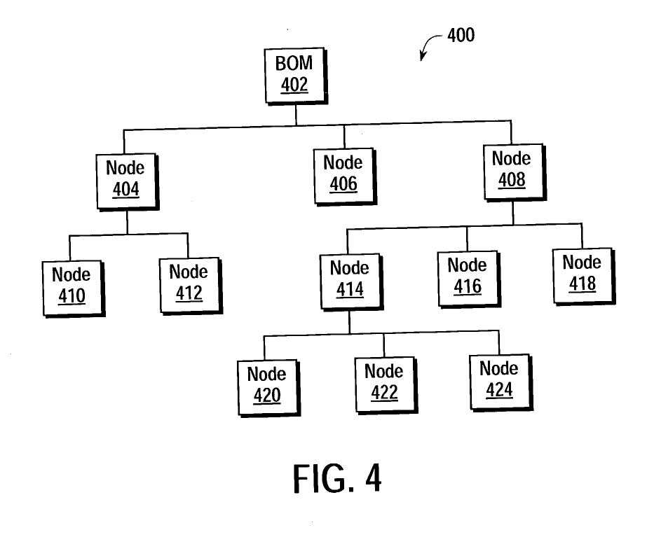

FIG. 4 is a block diagram illustrating an example traversal tree 400 having multiple nodes. Traversal tree 400 is associated with a bill of materials (BOM), represented by a node 402. The next level in traversal tree 400 contains three nodes 404, 406 and 408. Nodes 404, 406 and 408 may be referred to as “child” nodes of node 402. Similarly, node 402 may be referred to as a “parent” node of nodes 404, 406 and 408. Each node 404-408 identifies, for example, a particular component or service contained in the bill of materials. Node 404 has two associated nodes 410 and 412 in the next level of the traversal tree 400. For example, nodes 410 and 412 may identify sub-components or sub-services of the component or service identified in node 404.

Node 408 has three associated nodes 414, 416 and 418 in the next level of the traversal tree 400. In a particular embodiment, nodes 414-418 may identify sub-components or sub-services of the component or service identified in node 408. Node 414 further has three associated nodes 420, 422 and 424 in the next level of the traversal tree 400. These nodes may identify sub-components or sub-services of the component or service identified in node 414.

Each node in traversal tree 400 contains information regarding the node's relationship to other nodes in the traversal tree. Additionally, a particular node may contain, for example, information regarding a part number, manufacturing instructions and other data related to a component associated with the particular node. In the case of a service associated with a particular node, the node contains, for example, information regarding performing the service and defining how to handle the results of the service.

FIG. 4 illustrates one example of a traversal tree containing a specific arrangement of nodes. Alternate traversal trees may contain any number of nodes arranged in any configuration.

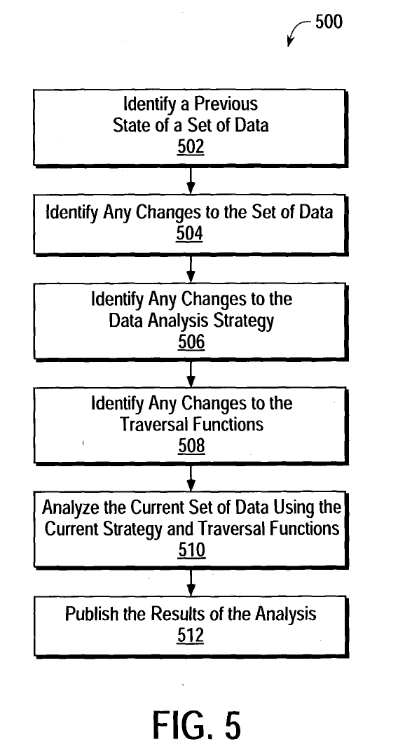

FIG. 5 is a flow diagram illustrating a procedure 500 for identifying the impact of a change on a set of data. Initially, procedure 500 identifies a previous state of a set of data (block 502). The previous state of the set of data can be identified by accessing a previously stored copy of the set of data. Alternatively, the previous state of the set of data can be identified by “reversing” changes made to the set of data that resulted in the current set of data.

Procedure 500 continues by identifying any changes to the set of data (block 504). Changes to the set of data may be contained, for example, within the set of data itself or stored in a separate listing or separate data file. The procedure then identifies any changes to the data analysis strategy (block 506) and identifies any changes to the traversal functions (block 508). The data analysis strategy and the traversal functions are stored in analysis parameter module 106 (FIG. 1), as discussed above. Procedure 500 continues by analyzing the current set of data using the current data analysis strategy and the current traversal functions (block 510). This analysis may include comparing the current set of data to one or more other sets of data. The analysis is performed by traversing the set of data and performing various functions or actions at different data elements. After completing this analysis, the procedure publishes the results of the analysis (block 512). Publishing the results of the analysis may include identifying the differences between different analyses (e.g., applying different analysis strategies or analyzing different sets of data). Alternatively, publishing the results of the analysis may include illustrating differences between different sets of data. Further, publishing the results of the analysis may include generating one or more events that are communicated to other components, systems, or procedures.

In a particular embodiment, a graphical representation of the traversal tree is displayed after procedure 500 completes execution. The graphical representation of the traversal tree highlights nodes of the tree that have changed as a result of executing procedure 500. When a user selects a particular node in the traversal tree (e.g., by selecting it with a mouse or other pointing device), the parameters and data associated with the node are displayed. Alternatively, when a user selects a particular node in the traversal tree, the changed parameters and data associated with the node are displayed.

In a particular embodiment, a tree (or a data hierarchy) is displayed that contains multiple colors such that each color is associated with a different analysis process. For example, the results of a previous analysis process can be displayed in blue while the results associated with a later analysis process (with changed data) are displayed in red.

In a particular instance, a user may execute procedure 500 after changing one or more data elements in the set of data. The procedure applies the same data analysis strategy and traversal functions to the modified set of data. In another instance, a user may execute procedure 500 on an unchanged set of data, but using a different data analysis strategy and/or a different set of traversal functions.

There are several different types of changes that can be made to a set of data: “Add”, “Update” and “Delete”. An “Update” change or a “Delete” change is associated with an underlying object and represents a change in the attributes of the underlying object. An “Add” change represents a new entry in the set of data. In a particular example, when the revision level of a particular item (item “I”) changes from A to B, the following changes occur:

New BomEntry I5

Delete BomEntry I3

Update BomEntry I4

These changes can be modeled as:

Add an entry for the new Rev B, which is tied to Rev A of I

Add an entry for BomEntry I5, related to Rev A of I

Delete an entry from BomEntry I3, related to BomEntry I3

Update entry for BomEntry I4, related to BomEntry I4

Various types of changes can be handled by the systems and methods discussed herein. Example changes include changes in the analysis strategy, changes in the set of data being analyzed and changes in the traversal functions. A change in analysis strategy results from changes to one or more analysis tasks to be performed by an analysis module. For example, a change in analysis strategy may include a change in price selection strategy, a change in the manufacturing timeline, or a change in the supplier selection strategy. The traversal description of a change in analysis strategy specifies the new analysis task to call instead of the old analysis task. An analysis task that performs no function may be used to implement deletion of an analysis task.

When a change in the set of data is being analyzed, the analysis process recomputes the traversal functions in view of the changed data. When one or more traversal functions are changed, the new traversal functions are called instead of the old traversal functions. A traversal task that performs no function can implement the deletion of an analysis task.

The analysis of one or more changes causes the traversal tree to be converted into a multi-scenario analysis tree. The multi-scenario analysis tree contains information regarding the results of the analysis performed before the changes and the results of the analysis performed after the changes. The multi-scenario analysis tree allows users to view the analysis results as well as details regarding how the results were obtained. For example, a user may view the prices that were considered and the analysis strategy used to generate a particular result. In a particular embodiment, two different sets of analysis results may be displayed side-by-side. In another embodiment, two different sets of analysis results may be displayed in a single tree (or other data structure) using different colors for each set of results.

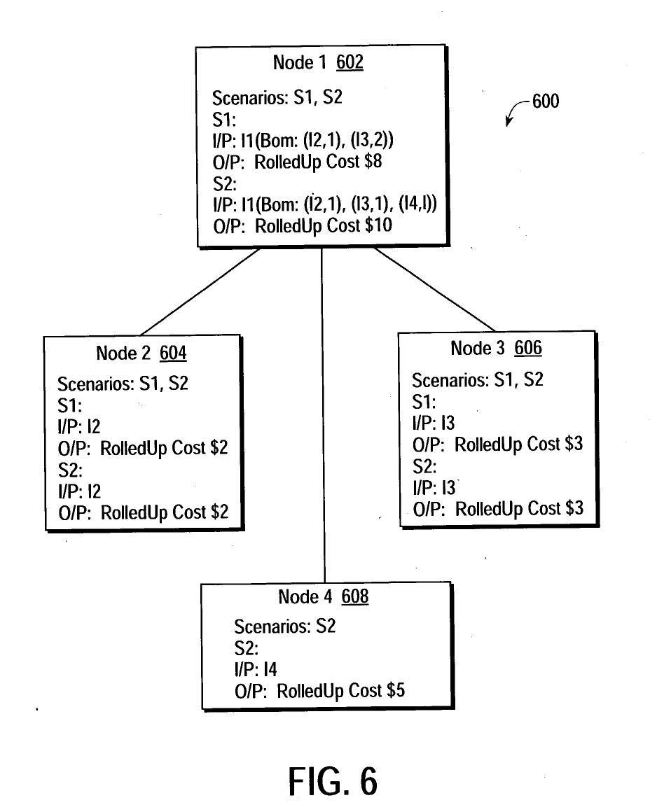

FIG. 6 illustrates an embodiment of a multi-scenario analysis tree 600 (also referred to as a multi-scenario tree). Tree 600 contains four nodes, each of which is associated with a particular item in a bill of materials. For example, a node 602 is associated with item one (referred to as I1), another node 604 is associated with a second item (referred to as I2), a node 606 is associated with a third item (referred to as I3) and a node 608 is associated with a fourth item (referred to as I4).

Each node in tree 600 represents the execution of a rule in an analysis process. Each node identifies the input object for which the rule was executed. One or more analysis tasks generate an output. The output is described by an output schema and is stored in the node. The output of the traversal tasks is a set of objects to process. The relationship between the source object on which a traversal task was executed and the objects that need to be processed (as defined by the output of the traversal task) is illustrated as parent-child nodes. The nodes that represent the objects to be visited point to the parent node, and the parent node points to the nodes that represent the objects to be visited.

Nodes also identify the relationship between the different scenarios. A particular node can be associated of one or more scenarios. Each node is tagged with information indicating the scenario(s) with which they are associated. Each scenario may have its own input and output objects. These objects are related to each other as change objects. In a primary scenario, the node may be associated with an item object. In a secondary scenario, the node may be associated with an item that represents a change from the item in the primary scenario. The parent-child relationship between nodes can be scenario-specific. Thus, a node is a child in a specific scenario if the node is a child node and it is associated with the specific scenario.

In the example of FIG. 6, node 602 identifies two scenarios, identified as scenario S1 and scenario S2. Scenario S1 includes the following bill of materials:

I1
I2 1 $2
I3 2 $3

The above bill of materials indicates that item I1 contains one of item I2 and two if item I3. The bill of materials further indicates that the cost it item I2 is $2 and the cost of item I3 is $3. Scenario S2 includes the following bill of materials in which the quantity of item I3 has been changed from 2 to 1 and item I4 has been added:

I2
I2 1 $2
I3 1 $3
I4 1 $5

Node 602 in FIG. 6 illustrates information related to item I1 and the cost associated with item I1. In scenario S1, the total cost (referred to as the “RolledUp Cost”) is $8 (which is calculated: $2+(2×$3)). In scenario S2, the total cost is $10 (which is calculated: $2+$3+$5). As mentioned above, nodes 604, 606 and 608 contain information related to items I2, I3 and I4, respectively.

A data source represents a database of objects of various types. The schema of a data source describes the types of objects in the data source. A “change data source” captures changes (such as adds, updates and deletes) made to objects in the data source. The change data source captures changes made to objects in the original source as redlines. A change data source is a type of data source and can be used in the same manner as any other data source. Objects in a change data source can be queried for their redlines. An example change is described below.

An original data source includes the following:

ds = Create a Datasource
ds.setupSchema(Item Class definition)
i1 = new Object(key=I1, datasource=ds, type=Item, ipn=I1, isRoot=true)
i2 = new Object(key=I2, datasource=ds, type=Item, ipn=I2, isRoot=false)

| i1.bom= | [ |
|---|---|
| | new object(key=b1, datasource=ds, type=BomEntry, |
| | parent=i1, child=i2, quantity=5) |
| | ] |

A change is created as follows:

cds = create change data source on ds
i1 = find i1 in cds
i4 =new Object(key=I4, datasource=ds, type=Item, ipn=I4, isRoot=false)

| i1.bom = | [ |
|---|---|
| | find b1 in cds |
| | new Object(key=b2, datasource=ds, type=BomEntry, |
| | parent=i1, child=i4, quantity=5) |
| | ] |

In one embodiment, finding an object is implemented using an array operator. Thus, finding i1 in ds is expressed as ds[i1]. For example, the expression “print ds[i1].bom” prints ((I2, 5)) and the expression “print cds[i1].bom” prints ((I2, 5), (I4, 5)). Additional functions may be provided that return the changed values of i1 in cds as redlines.

In a particular embodiment, analysis module 102 (FIG. 1) identifies a particular traversal definition and a bill of materials. Initially, the root of the bill of materials is an unprocessed object. Based on the traversal order, analysis module 102 creates a queue and places the root of the bill of materials in the queue. Analysis module 102 processes the top unprocessed element in the queue by placing the element on the multi-scenario traversal tree (e.g., associating the element with an existing node in a parent scenario). Analysis module 102 then locates a matching rule for the element and executes each task in the rule's task list. If a particular task is a traversal task the results of the traversal task are added to the queue. This process continues until all elements in the queue have been processed.

Exemplary Computer

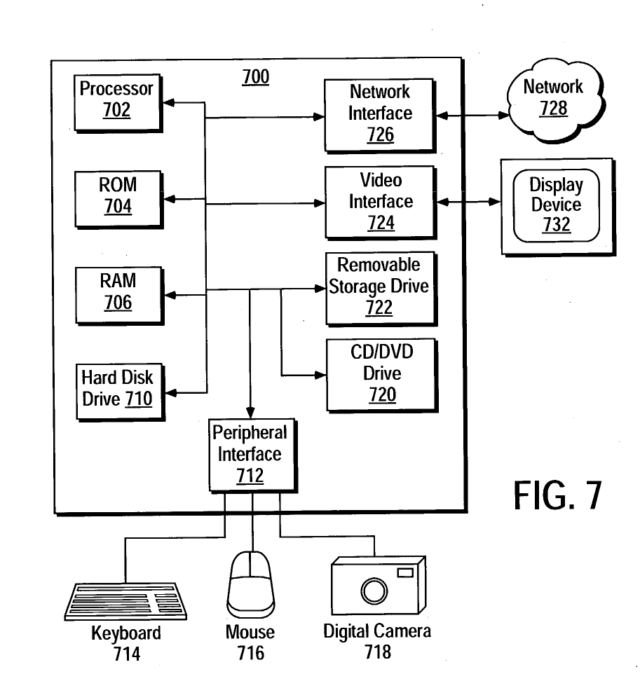

FIG. 7 shows an exemplary computing system 700 that may be used to implement, for example, an analysis module 102. Computer system 700 can be used to perform one or more of the various procedures and processes discussed herein.

Computer system 700 includes at least one processor 702 coupled to a bus 708. Bus 706 represents one or more of many different bus structures, such as a memory bus or memory controller, a peripheral bus, and a processor or local bus using any of a variety of bus architectures and protocols. Although a single bus is shown in FIG. 7, alternate embodiments may use two or more different buses for communicating data.

A Read-Only Memory (ROM) 704 and a Random Access Memory (RAM) 706 are also coupled to bus 708. A hard disk drive 710, a CD/DVD drive 720 and a removable storage drive 722 are also coupled to bus 708. Hard disk drive 710 provides for the non-volatile storage of data. CD/DVD drive 720 accommodates removable storage media (i.e., CD-ROMs and DVDs) that stores data, such as application programs. Removable storage drive 722 provides an additional storage device for various types of data. Removable storage drive 722 may be, for example, a floppy disk drive, tape drive, or other storage drive that uses optical, magnetic or other data storage technologies. Other types of storage devices (not shown) that could be utilized by computer system 700 include PCMCIA cards and flash memory cards.

A variety of program modules can be stored in the memory devices 704 or 706, or in another storage device. These program modules include an operating system, a server system, one or more application programs, and other program modules and program data. In a networked environment, some or all of the program modules executed by computer system 700 may be retrieved from another computing device coupled to the network.

A peripheral interface 714 is coupled to bus 708 to provide an interface for individual peripheral devices. Exemplary peripheral devices include a keyboard 714, a mouse 716 and a digital camera 718. Other peripheral devices (not shown) include a keypad, a touch pad, a trackball, a microphone, a joystick, speakers, a printer, a scanner and the like.

A video interface 724 is coupled to bus 708 and a display device 732 (e.g., a monitor, an LCD, a TV, a video projector, etc.). A network interface 726 is coupled to bus 708 and one or more data communication networks 728, such as the Internet. Network interface 726 may include, for example, a network interface card (NIC), a modem, a satellite receiver, or an RF transceiver. Data communication network 728 may be a local area network (LAN), a wide area network (WAN), or any other network capable of communicating data between nodes.

Typically, computer system 700 is programmed using instructions stored at different times in the various computer-readable media of the computer. Programs and operating systems are often distributed, for example, on floppy disks or CD-ROMs. The programs are installed from the distribution media into a storage device within computer system 700. When a program is executed, the program is at least partially loaded into the computer's primary electronic memory. These and other types of computer-readable media contain instructions or programs for implementing various processes described herein.

Memories 704 and 706, hard disk drive 710, CD/DVD drive 720 and removable storage drive 722 provide for the storage of data (e.g., computer-readable instructions, data structures, program modules and other data used by computer system 700).

Computer system 700 is exemplary only—additional components may be included in system 700 and/or some components may not be included in system 700. By way of example, computer system 700 may include co-processors that operate in conjunction with processor 702. By way of another example, a wireless computing device may include a wireless transceiver, but not include removable storage drive 722.

Conclusion

Although the description above uses language that is specific to structural features and/or methodological acts, it is to be understood that the invention defined in the appended claims is not limited to the specific features or acts described. Rather, the specific features and acts are disclosed as exemplary forms of implementing the systems and methods discussed herein.

1. A method comprising:
identifying a first set of analysis results based on a first set of data and an analysis strategy;
identifying a second set of data to analyze, wherein the second set of data is a modification of the first set of data;
analyzing the second set of data using the analysis strategy to generate a second set of analysis results, wherein the second set of analysis results are arranged in a hierarchical format; and
comparing the first set of analysis results with the second set of analysis results to identify differences in the two analysis results.

2. The method of claim 1, wherein the first set of analysis results are arranged in a hierarchical format.

3. The method of claim 1, wherein the analysis strategy includes a plurality of data analysis tasks.

4. The method of claim 1, further comprising publishing the results of comparing the first set of analysis results with the second set of analysis results.

5. The method of claim 1, further comprising illustrating the differences in the two analysis results in a hierarchical format.

6. The method of claim 1, wherein the first set of data is collected from a plurality of data sources.

7. The method of claim 1, wherein the first set of data represents a bill of materials.

8. The method of claim 1, wherein the second set of data is received from a plurality of data sources.

9. A method comprising:
identifying a first set of analysis results based on a set of data and a first analysis strategy;
identifying a second analysis strategy, wherein the second analysis strategy is a modification of the first analysis strategy;
analyzing the set of data using the second analysis strategy to generate a second set of analysis results; and
comparing the first set of analysis results with the second set of analysis results to identify differences in the two analysis results.

10. The method of claim 9, wherein the first set of analysis results and the second set of analysis results are arranged in a hierarchical format.

11. The method of claim 9, wherein the set of data represents a bill of materials.

12. The method of claim 9, wherein analyzing the set of data using the second analysis strategy includes merging the second set of analysis results with the first set of analysis results.

13. A method comprising:
identifying a set of analysis results based on a bill of materials and an analysis strategy;
identifying a second set of data to analyze, wherein the second set of data is a modification of the first set of data;
applying the analysis strategy to the second set of data;
merging the set of analysis results with the results of applying the analysis strategy to the second set of data; and
publishing the merged analysis results.

14. The method of claim 13, wherein the merged analysis results are arranged in a hierarchical format.

15. The method of claim 13, wherein the first set of data is a bill of materials.

16. An apparatus comprising:
an analysis parameter module configured to store at least one analysis task; and
an analysis module coupled to the analysis parameter module, the analysis module being configured to identify a first set of analysis results based on a first set of data and an analysis strategy, the analysis module further configured to identify a second set of data to analyze, wherein the second set of data is a modification of the first set of data, the analysis module further configured to analyze the second set of data using the analysis strategy to generate a set of analysis results, the analysis module further configured to compare the first set of analysis results with the second set of analysis results to identify differences in the two analysis results.

17. The apparatus of claim 16, wherein the analysis module is further configured to perform a plurality of data analysis tasks.

18. The apparatus of claim 16, wherein the analysis module is further configured to publish the results of the analysis.

19. The apparatus of claim 16, wherein the analysis module is further configured to illustrate the differences in the two analysis results.

20. The apparatus of claim 16, wherein the analysis module is further configured to receive the at least one analysis task from the analysis parameter module.
